(19) United States
(12) Patent Application Publication
(10) Pub. No.: US 2012/0036764 A1
(43) Pub. Date: Feb. 16, 2012

(54) CARBON MATERIAL CONVERSION PROCESS COMPRISING TWO LIQUEFACTION STAGES IN A BOILING BED IN THE PRESENCE OF HYDROGEN GENERATED BY NON-FOSSIL SOURCES

(75) Inventors: Celine BABE, Villeurbanne (FR); Raphael Huyghe, Saint Andeol Le Chateau (FR); Alain Quignard, Roussillon (FR); Wilfried Weiss, Valencin (FR)

(73) Assignee: IFP Energies nouvelles, Rueil-Malmaison Cedex (FR)

(21) Appl. No.: 13/186,060

(22) Filed: Jul. 19, 2011

(30) Foreign Application Priority Data
Jul. 20, 2010 (FR) 10/03.046

(51) Int. Cl. C10L 1/00; C10G 1/08

(52) U.S. Cl. 44/307; 208/413; 44/300

(57) ABSTRACT

A process for converting carbon material into fuel bases comprising two liquefaction stages in the presence of hydrogen in a boiling-bed reactor containing a supported catalyst and integrating a hydrogen production stage generated by non-fossil sources that do not emit CO₂. The hydrogen production stage comprises the gasification of biomass and/or the decomposition of water, hydrochloric acid, hydrogen chloride or hydrogen sulfide by thermal, electrolytic, chemical or biological processes. The thus produced hydrogen is sent into at least one of the liquefaction stages.

This invention relates to a process for direct liquefaction of carbon material in a boiling bed in the presence of hydrogen including a stage for producing hydrogen generated by non-fossil sources and produced without CO₂ emissions.

The transportation sector is a major consumer of energy and today essentially depends on the non-renewable resource of petroleum. On the environmental plane, the combustion of fuels greatly contributes to greenhouse gas (GHG) emissions, in particular CO₂. Within a context of climate change and petroleum dependence, it is therefore necessary to diversify fuels. The alternatives to the use of petroleum are potentially numerous: natural gas, coal, biomass, and the following energies: hydraulic, wind, solar, marine or nuclear.

Taking into account the abundant coal reserves, an attractive alternative is the liquefaction of coal for the production of fuel bases. The liquefaction of coal that is more known under the English term “Coal-to-Liquids” or “CTL” consists of the conversion of coal into liquid hydrocarbons such as the fuels or products of petrochemistry. The liquefaction of coal rests on two different design pathways:

The so-called “indirect” pathway, based on a 1913 BASF patent and works of the chemists Fischer and Tropsch in 1922, consists, in a first step, in gasifying the coal into gas that consists of carbon monoxide and hydrogen, called synthetic gas. This gas is then converted into liquid hydrocarbons by the Fischer-Tropsch process that uses iron catalysts. This process makes it possible to use standard coals of bituminous and sub-bituminous types and also coals that are not very mature, such as lignites. The indirect pathway, also known under the English term “Indirect Coal Liquefaction” or “ICL,” is used commercially in South Africa.

The so-called “direct” pathway, based on the works of Bergius in 1913, consists in reacting the coal in a solvent in the presence of hydrogen at high temperatures and pressures to produce liquid hydrocarbons. The products of the direct liquefaction are then treated and purified to enable the products to meet the applicable specifications. This liquefaction process is often limited to coals of bituminous and sub-bituminous types. The direct pathway, also known under the English term “Direct Coal Liquefaction” or “DCL,” is used commercially in China.

It is important to emphasize that the liquefaction of coal, whether it is direct or indirect, is above all a problem of hydrogen content. The composition of the coal, low in hydrogen (H/C ratio close to 0.6-0.8), does not make it possible to obtain fuel bases (H/C ratio close to 2) without a massive addition of hydrogen. The hydrogen that is necessary for reaction is generally provided from natural gas by vaporeforming or else, if the sole primary energy source available is coal (which is generally the case of a factory that is installed in the immediate vicinity of the mine), by gasification of coal. The gasification of coal nevertheless produces—besides the desired hydrogen—significant quantities of CO₂, which exhibits increased pollution that is difficult to accept in an international context of greenhouse gas reduction. In the case of indirect liquefaction, the GHG emissions during the production of the fuel bases are greater than the emissions during the consumption of fuel bases produced by this process. Although this ratio is more advantageous in the case of direct liquefaction, it is estimated that 80% of the CO₂ emissions originate from the gasification of coal for producing hydrogen. The remaining 20% originates from the combustion of coal (or gas) in the heating furnaces that are necessary for liquefaction.

Thus, the coal liquefaction line can undergo significant development only upon the express condition of either integrating the capture and storage of CO₂ or using hydrogen that is produced from the sources that do not emit greenhouse gases, or else combining these two pathways. In terms of the CO₂ balance, emphasis is to be placed on the use of hydrogen that is produced from resources that do not emit GHG.

The object of this invention is then to propose a process for liquefaction of carbon material by a direct pathway limiting the GHG emissions and in particular CO₂.

### PRIOR ART

The processes for liquefaction of coal by a direct pathway are known in the prior art.

In the 1960s, Hydrocarbon Research, Inc., developed a process for direct liquefaction of coal, called “single-stage H-Coal,” which is described in U.S. Pat. No. 3,519,553. This process uses a boiling-bed reactor with a hydroconversion catalyst.

So as to increase the yields of fuel bases, a process that uses two successive boiling-bed reactors was developed by the same company in the 1970s, called “two-stage H-Coal” or “H-Coal TS.®” Thus, the U.S. Pat. No. 4,874,506 describes a process for direct liquefaction of coal in two successive stages using boiling-bed reactors. In this process, in a first step, the carbon is ground and mixed with a solvent that is generated by the process for forming a suspension that is then injected into the first boiling-bed reactor in the presence of a hydroconversion catalyst. The partially hydrogenated effluent is then injected directly into a second boiling-bed reactor that operates under slightly stricter operating conditions. The hydrogen source is not specified.

The application US2008/0103220 describes the combination of one hydrogen production process from non-fossil sources, in particular via the nuclear line, with the indirect CTL pathway. The hydrogen (and oxygen) are produced by decomposition of water (for example, by electrolysis of water) using nuclear energy. The oxygen is used for the gasification of coal for producing the synthetic gas that is used in the Fischer-Tropsch process. Hydrogen is used to obtain the good H₂/CO ratio (synthetic gas) in the Fischer-Tropsch process.

### OBJECT OF THE INVENTION

The issue for the industrial development of the direct liquefaction of carbon material is therefore to limit the greenhouse gas emissions generally produced during the production of hydrogen that is necessary for the process by gasification of fossil sources.

The purpose of this invention is to improve the process for direct liquefaction of coal that is known under the name “H-Coal TS” for limiting the GHG emissions by integrating a stage for the production of hydrogen originating from non-fossil sources that do not emit CO₂.

Although the integration of a stage for producing hydrogen generated by non-fossil sources was developed for the direct liquefaction of coal, it can also be applied to the indirect liquefaction of coal as well as to the direct and/or indirect liquefaction of the biomass, algae and/or feedstocks generated by petroleum and therefore to the liquefaction of any carbon material. Likewise, it can also be applied in liquefaction processes by co-processing different carbon materials. For the sake of simplification, the term “H-Coal” or direct liquefaction of coal used below covers any process for direct liquefaction of carbon material.

In its broadest form, this invention is defined as a process for converting carbon material into fuel bases comprising the following stages:
a) Liquefaction of said carbon material in the presence of hydrogen in at least one reactor that contains a catalyst that is supported in a boiling bed,
b) Liquefaction of at least a portion of the effluent that is obtained in stage a) in the presence of hydrogen in at least one reactor that contains a catalyst that is supported in a boiling bed and that operates at a temperature that is at least 10° C. higher than that of stage a),
   whereby said process is characterized in that it comprises a hydrogen production stage that uses at least one non-fossil source, with the thus produced hydrogen being at least partially or completely introduced into at least one of the liquefaction stages.

The research work carried out by the applicant on the direct liquefaction of coal led him to discover that this process for direct liquefaction in two successive stages in a boiling bed including a stage for producing hydrogen that is generated by non-fossil sources made it possible to incorporate more carbon contained in the coal in the fuel bases and therefore to considerably lower the CO₂ emissions relative to the conventional direct liquefaction process using the hydrogen that is produced by gasification of coal. Likewise, the conversion of coal into liquid products is increased by more than 50%.

Relative to the direct liquefaction in a single stage, the liquefaction in two stages makes it possible to obtain products of better quality and with better yield. This is reflected by a larger hydrogen requirement in this process, hence the advantage of producing hydrogen according to this invention. Likewise, the products of better quality limit the requirements for energy and hydrogen in optional post-treatments (hydrotreatment, hydrocracking, . . . ), which can therefore be carried out under less stringent operating conditions.

Another advantage of this invention is the fact that the direct liquefaction makes it possible to obtain higher yields of fuel bases while offering lower CO₂ emissions relative to the indirect liquefaction.

Another advantage of this invention is the fact of being able to supply the stage for producing hydrogen by non-fossil energies that do not emit CO₂ or that are neutral in terms of CO₂ emissions, such as nuclear energy and/or renewable energies. Thus, the reduction of emissions can be done at two levels: the non-fossil source of hydrogen and non-fossil energy that is necessary for producing hydrogen from this source.

Another advantage of this invention is the possibility of integrating processes for capture and storage of CO₂ from emissions emitted in the process during the production of utilities, such as heat, steam and/or electricity, and/or during the production of hydrogen. The emissions can originate from, for example, heating furnaces that are necessary for liquefaction, gasification of a fossil source for supplementing the production of hydrogen, or the production of hydrogen by vaporeforming of natural gas or light hydrocarbon fractions, preferably generated by the liquefaction process or else the gasification of the biomass in the stage for producing hydrogen that is generated by non-fossil sources. This offers the advantage of limiting the GHG emissions all the more: on one hand, the production of CO₂ is prevented per se by integrating the stage for producing hydrogen that is generated by non-fossil sources, and on the other hand, the CO₂ that is produced is captured either for utility requirements or for the production of additional hydrogen.

If necessary, the hydrogen that is generated by non-fossil sources that is necessary for liquefaction can be supplemented by hydrogen that originates from a gasification of fossil sources, for example a gasification of coal, petroleum waste and/or preferably waste that is generated by liquefaction. Hydrogen can also originate from a vaporeforming of natural gas or non-conventional gases that are rich in methane or else a vaporeforming of light hydrocarbon fractions, preferably generated by the liquefaction process. In this case, the CO₂ that is produced during gasification and/or vaporeforming is preferably captured and stored so as to lower the GHG emissions Likewise, the oxygen that is necessary for gasification preferably originates from electrolysis of water, used for the production of hydrogen from non-fossil sources.

In the case of a gasification of biomass for the production of hydrogen that is generated by non-fossil sources, the CO₂ that is released during gasification is compensated for by the CO₂ that has been absorbed during photosynthesis during the growth of the plants that are used. In this case, the CO₂ balance is neutral. In addition, this released CO₂ is preferably captured and stored. In this case, the CO₂ balance is negative.

It is also possible, of course, to consider a biomass-fossil source co-gasification (coal, petroleum waste and/or waste that is generated by liquefaction) and preferably a biomass-waste co-gasification that is generated by liquefaction.

### DETAILED DESCRIPTION

### The Feedstock

The carbon material that is used in the direct liquefaction process can be coal, biomass, algae, feedstocks that are generated by petroleum and/or petroleum refining, products that are generated by thermochemical or hydrothermal conversion of these feedstocks and/or hydrocarbon wastes. These feedstocks can be used alone or as a mixture of two or more of them in equal or different proportions.

In the case of coal, the feedstock that is used is preferably of the bituminous or sub-bituminous type. However, lignites can also be used.

In the case of biomass, the feedstock that is used is a feedstock that is generated by renewable sources, such as, for example, oils and fats of vegetable or animal origin, lignocellulosic biomass, or one or more components of lignocellulosic biomass selected from the group that is formed by cellulose, hemicellulose and/or lignin, or mixtures of such feedstocks.

The vegetable or animal oils contain triglycerides and/or free fatty acids and/or esters. The vegetable oils can advantageously be raw or refined, completely or partially, and are generated by, for example, the following vegetables: canola, sunflower, soy, palm, palm kernel, olive, coconut, jatropha, whereby this list is not limiting. The oils of algae or fish are also pertinent. The oils can also be produced from genetically modified organisms. The animal fats are advantageously selected from among lard or fats that consist of waste from the food industry or that are generated by catering industries.

The lignocellulosic biomass can consist of wood or plant wastes. Other nonlimiting examples of lignocellulosic biomass material are the waste from agricultural operations (straw), waste from forestry operations (initial cutting products), products from forestry operations, dedicated crops (short-rotation shrubs), waste from the farm produce industry, household organic waste, waste from wood transformation installations, scrap wood from construction, or paper that may or may not be recycled. The lignocellulosic biomass can also originate from by-products of the paper-making industry, such as the Kraft lignin or black liquors generated by the production of pulp.

In the case of algae, the feedstock that is used can be macroalgae and/or microalgae. Thus, the feedstock can consist of prokaryotic organisms such as blue algae or cyanobacteria or eurokaryotic organisms such as single-cell species groups (euglenophytes, cryptophytes, haptophytes, glaucophytes, etc.), groups of single-cell or multi-cell species such as red algae or rhodophyta, and stramenopiles that combine in particular diatoms and brown algae or phaeophyceae. Finally, the feedstock can also consist of macroalgae such as green algae (causing aquatic weed pollution), kelp, or wrack (also called seaweed).

All products or a mixture of products generated by the thermochemical conversion of the biomass or algae, such as, for example, wood coal or pyrolysis oil of lignocellulosic biomass, of the pyrolytic lignin (obtained by extraction of pyrolysis oil) or else products of the hydrothermal conversion of the lignocellulosic biomass in the presence of a high concentration of water and under a high water pressure under subcritical or supercritical conditions of water and in the absence or in the presence of catalysts also offer usable feedstocks.

In the case of petroleum, the hydrocarbon feedstocks that are involved are feedstocks such as petroleum waste, vacuum distillates of petroleum origin, crude oils, synthetic crudes, topped crude oils, deasphalted oils, deasphalting resins, asphalts or deasphalting tars, derivatives of the processes for converting petroleum (such as, for example: the light gas oil of catalytic cracking (also called “light cycle oil” or “LCO” according to English terminology), the heavy gas oil of catalytic cracking (also called “heavy cycle oil” or “HCO” according to English terminology), fluid catalytic cracking waste (also called “fluid catalytic cracking” or “FCC” according to English terminology), the heavy gas oil or the vacuum gas oil (also called “vacuum gas oil” or “VGO” according to English terminology) of coking, the waste from visbreaking or a similar thermal process such as petroleum coke, etc.), aromatic extracts that are generated by production chains of bases for lubricants, bituminous sands or derivatives thereof, bituminous shale or derivatives thereof, or mixtures of such feedstocks. More generally, feedstocks that contain at least 50% by weight of product distilling above 250° C. and at least 25% by weight distilling above 350° C. will be combined under the term hydrocarbon feedstocks of petroleum.

Other feedstocks in question are feedstocks such as hydrocarbon waste and/or industrial polymers such as, for example, recycled polymers from used tires, waste from polymer residues originating from, for example, recycled automobiles, organic waste or plastic household waste, or mixtures of such feedstocks.

The feedstocks that contain at least a portion of the effluents that are generated by Fischer-Tropsch synthesis, produced from synthetic gases produced by gasification of feedstocks of the following types: petroleum, non-petroleum (coal, gas) or renewable (biomass, algae), can also be used as a feedstock. The tars and waste generated by said gasification can also be used as a feedstock; the latter generally cannot be upgraded or are difficult to upgrade.

### Pretreatment

The carbon material can be introduced in liquid or solid form into the first liquefaction reactor. In the case of the carbon material being introduced in liquid form, it can be introduced without pretreatment and/or without being put in suspension, such as, for example, in the case of feedstocks that are generated by petroleum. In the case of the introduction of the carbon material in solid form (for example, coal, lignocellulosic biomass, . . . ), it is suitable to prepare—before its introduction—a suspension of particles of carbon material in a solvent. The carbon material, after optional pretreatment stages described below, is mixed with a solvent, preferably a hydrogen donor solvent that comprises, for example, tetralin and/or naptheno-aromatic molecules. The solvent can also comprise atmospheric distillate and/or atmospheric waste and/or vacuum distillate, preferably vacuum gas oil and/or vacuum waste. Said solvent is preferably a recycled fraction that is generated by a separation stage that is carried out after the two liquefaction stages, whereby said solvent is recycled upstream from the two liquefaction stages and advantageously contains a fraction of vacuum gas oil type. In the case of a co-treatment with other feedstocks, the solvent can also consist partially or completely of a liquid co-feedstock.

The carbon material/solvent mixture is a suspension of particles of carbon material dispersed into said solvent, whereby said suspension of fine solid particles in a liquid is also occasionally called “slurry” according to English terminology. For the sake of simplification, the term of suspension will be used below. To constitute the suspension, the size of the particles of the carbon material is less than 5 mm, preferably less than 1 mm, preferably less than 600 microns, and even preferably less than 150 microns. The solvent/carbon material mass ratio is generally 0.1 to 3, preferably 0.5 to 2.

The solvent plays a triple role: Suspending the feedstock in “slurry” upstream from the reaction zone, thus making it possible to transport it toward the latter, and then partial solubilization of the primary products for conversions, and transfer of hydrogen to these primary products for making possible a conversion into liquid by minimizing the quantity of solids and gases formed in said reaction zone. This transfer of hydrogen therefore offers an additional hydrogen source for the essential requirement for hydrogen in the transformation of carbon material into fuels.

Before the liquefaction, the carbon material can undergo one or more pretreatment stages. In a general manner, the feedstock preferably undergoes a pretreatment that reduces its moisture content and a stage for reducing the size of the particles until reaching the size range that is suitable for the composition of a carbon material/solvent suspension for the treatment in the liquefaction process. These stages are optional and can be executed in any order relative to one another. Preferably, drying is implemented first, followed by grinding.

The technologies that are known for drying are, for example, the rotary furnace, the moving bed, the fluidized bed, the heated endless screw, and the contact with metal balls that provide heat. These technologies can optionally use a gas that circulates in co-current or counter-current such as nitrogen or any other inert gas under the conditions of the reaction. The drying stage is implemented at a temperature that is less than 250° C., preferably less than 200° C. The dried material is then sent into a mill that makes it possible to achieve the desired grain size for the purpose of its liquefaction. The grinding prior to liquefaction facilitates the transportation to the reaction zone and promotes gas/liquid/solid contacts.

Pretreatments that are specific to the feedstock can be added and can be implemented in any order in the pretreatment stages of optional drying and grinding.

The coal optionally undergoes a pretreatment that reduces its content of ash before the drying and grinding. These technologies are technologies that are known by one skilled in the art such as washing operations, extractions and physical and/or mechanical separations. The washing operations and extractions can be done by using water, optionally acidic or basic aqueous solutions, organic products that are optionally generated by a liquefaction process, or else mixtures of water and organic products. These washing operations or extractions are generally combined with physical and/or mechanical separations that use the difference in floatability of coal particles and ash, or else the density difference between the coal and the ash, which are primarily minerals that are heavier than coal. These techniques can require preliminary grinding and operations at different temperatures by means of heating and/or cooling methods.

In the case of a lignocellulosic biomass or one or more components of the lignocellulosic biomass, a roasting pretreatment can be added or can replace the drying stage. The drying and the roasting are different heat treatments. The first essentially eliminates the water that is contained in the biomass while the second creates modifications of the chemical structure of the components. The roasting can be defined as pyrolysis at a moderate temperature and a controlled dwell time because it accompanies not only a drying operation, but also a partial destruction of the lignocellulosic material. After roasting, the biomass particles have a more spherical and less rough shape, thus creating fewer agglomerates during the composition of the suspension. The roasting thus makes possible a more homogeneous fluidization in the boiling bed. The roasting stage is carried out at a temperature of between 200° C. and 300° C., preferably between 225° C. and 275° C., in the absence of air.

Prior to the optional drying and grinding stages, the algae preferably undergo a demineralization stage that is known by one skilled in the art so as to reduce the inorganic salts and metals that are harmful to liquefaction catalysts. Based on the feedstock and operating conditions, the demineralization also makes it possible to upgrade the alginates, products that are used as thickeners, gelling agents, and emulsifiers. This demineralization stage consists in passing the algae into several solutions or baths, optionally with different pH levels. Between each bath, there is generally a smaller or larger liquid/solid separation (decanting, filtration, or centrifuging) that makes it possible to recover the algae in the aqueous medium.

The pretreatment stages can be performed in decentralized mode close to the production of the carbon material and/or in a centralized mode, directly supplying the liquefaction.

After the pretreatment, particles of carbon material are obtained that have a moisture level of 1 to 50%, preferably 1 to 35%, and even preferably from 1 to 10%, as well as a size of particles that is less than 600 microns, preferably less than 150 microns. The carbon material is then mixed with a solvent to constitute a suspension for liquefaction.

Hydrogen from Non-Fossil Sources

The process according to the invention comprises a stage for producing hydrogen. The hydrogen that is necessary for the reaction is generated by non-fossil sources such as water, hydrochloric acid, hydrogen chloride HCl, hydrogen sulfide H₂S and/or biomass.

The stage for producing hydrogen that is generated by water comprises electrolytic, chemical and/or biological processes such as the decomposition of water by electrolysis, by high-temperature electrolysis, by thermochemical cycles, and/or by microorganisms.

The decomposition of water can be done in particular by:
Conventional electrolysis according to the general formula:

Electricity+H₂O(liquid)→H₂+O₂

Electrolysis is the process for chemical decomposition of water into oxygen and hydrogen under the action of an electric current. Industrial electrolysis is carried out in general from an aqueous solution of potassium hydroxide whose concentration varies based on the temperature (typically 25% by mass at 80° C. up to 40% at 160° C.). Potassium is preferred over soda, essentially for reasons of greater conductivity at an equivalent temperature level and better control of chloride and sulfate impurities.
Electrolysis at a high temperature (700 to 900° C.) and at reduced pressure according to the general formula:

Electricity+H₂O(steam)→H₂+O₂

High-temperature electrolysis is more effective than the ambient-temperature process since a portion of the energy that is necessary for reaction is provided via heat, less expensive to obtain than electricity, and the electrolysis reactions have a better yield at a high temperature.
Thermochemical cycles according to the general formula:

Heat+H₂O→[cyclic chemical reactions]→H₂+O₂

The thermochemical cycles generally operate at temperatures of between 800 and 1000° C. and use water as the raw material. They comprise the formation of hydrogen in one of their stages. The principle of these methods is to extract the hydrogen that is formed and to recycle the intermediate chemical reagents.

As thermochemical cycles, it is possible to cite the calcium-bromide process (decomposition of hydrobromic acid into hydrogen on the iron catalyst) or the sulfuric acid process via the electrolysis of sulfur dioxide according to SO₂+2H₂O→H₂SO₄+H₂, and then the decomposition of sulfuric acid, according to the diagram: H₂SO₄→SO₂+H₂O+½O₂. Another thermochemical cycle is the iodine-sulfur process: the formation of sulfuric acid according to the diagram: I₂+SO₂+2H₂O→2HI+H₂SO₄, and then the separation of the hydroiodic acid according to 2HI→I₂+H₂, and the separation of sulfuric acid, according to H₂SO₄→SO₂+H₂O+½O₂, whereby the latter reaction is endothermic and requires a temperature of at least 850° C. A variant for the separation of sulfuric acid is the Bunsen reaction, H₂SO₄+2HI→I₂+SO₂+2H₂O, which offers the advantage of taking place at a temperature on the order of 120° C.
Photosynthetic microorganisms such as, for example, certain green algae (for example, Chlamydomonas reinhardtii) and certain cyanobacteria, which produce hydrogen within bioreactors under the effect of light and in the absence of oxygen.

The stage for producing hydrogen that is generated by hydrochloric acid or hydrogen chloride comprises electrolytic and/or chemical processes. Thus, hydrogen can be produced via electrolysis of hydrochloric acid that uses CuCl or else the hexachloroiridate complexes IrCl₆³⁻ and IrCl₆²⁻. As a chemical process, it is possible to cite the reaction of hydrogen chloride with cerium dioxide at temperatures that are greater than 775° C. and that thus produce chlorine and hydrogen.

The stage for producing hydrogen that is generated by hydrogen sulfide comprises thermal and/or chemical processes. Thus, hydrogen sulfide can be decomposed thermally (1500° C.) in a direct manner according to the reaction H₂S→H₂+S. As a chemical process, it is possible to cite the process “Hysulf™,” developed by Marathon Oil Company, which is based on an oxidation-reduction cycle that uses anthraquinone derivatives. Another chemical process, developed by the applicant (WO2009/090316), is based on the reaction of metal oxides with hydrogen sulfide producing metal sulfides, water and hydrogen.

The stage for producing hydrogen according to this process can also be done by gasification of biomass. By this process, first synthetic gas CO+H₂ is produced, and then the hydrogen content is increased using the water-gas conversion reaction CO+H₂O→CO₂+H₂. The advantage of having recourse to the biomass is that the CO₂ that is released by the water-gas conversion is compensated for by the CO₂ that was absorbed during the photosynthesis during the growth of the plants that are used. In addition, the CO₂ that is released during the gasification is preferably captured by an absorption process. These processes are known by one skilled in the art; it is possible to cite the processes for adsorption by amines or by potassium carbonate. The gasification of the biomass therefore offers a neutral, and even negative balance (if there is capture of CO₂) in terms of greenhouse gas. Likewise, the energy expenditure that is necessary for producing two reactions (production of utilities) can be carried out by using biomass as fuel.

According to another aspect of this invention, the energy that is necessary for producing hydrogen according to the processes described above is preferably the non-fossil energy that does not emit CO₂ or that is neutral in CO₂ emissions. A non-fossil energy source is the nuclear energy of nuclear power plants that produces heat that can be used directly (for the thermochemical cycles) or that can be transformed into electricity (for electrolysis). Other energy sources without GHG emissions or neutral in GHG are the renewable energies such as photovoltaic solar energy, low-temperature thermal solar energy (production of hot water), high-temperature thermal solar energy (production of electricity), wind energy, hydraulic or hydroelectric energy, marine energies, geothermal power and/or biomass. These non-fossil energies can be used alone or in combination with two or more of them in equal or different proportions.

According to this invention, the non-fossil source is preferably water, with hydrogen preferably being produced by conventional electrolysis; the energy for this electrolysis is preferably provided by renewable energies, preferably by solar energy, geothermal power and/or biomass. Actually, these energies are distinguished by an almost inexhaustible abundance, and an easy accessibility, and they produce few if any problematic wastes.

According to another aspect of this invention, processes for capture and storage of CO₂ from emissions that originate from the process can be integrated so as to reduce the GHG emissions even further. In a general manner, these emissions are emitted during the production of utilities such as heat, steam and/or electricity, and/or during the production of additional hydrogen. The emissions can originate, for example, from heating furnaces that are necessary for liquefaction, the gasification of a fossil source for supplementing the hydrogen production, or the production of hydrogen by vaporeforming of natural gas or non-conventional gases that are rich in methane or light hydrocarbon fractions, preferably generated by the liquefaction process, or else the gasification of the biomass in the stage for producing hydrogen that is generated by non-fossil sources. The CO₂ that is contained in the emissions is preferably captured by an absorption process. These processes are known by one skilled in the art; it is possible to cite the processes for absorption by amines and/or by potassium carbonate.

If necessary, the hydrogen that is generated by non-fossil sources that is necessary for liquefaction can be supplemented by the hydrogen that originates from a gasification of fossil sources and/or vaporeforming. Thus, this process can comprise a stage for producing hydrogen by gasification of at least one fossil source that is selected from among coal, petroleum waste and/or preferably waste that is generated by liquefaction, whereby the hydrogen that is thus produced is at least partially or completely introduced into at least one of the liquefaction stages. Hydrogen can also originate from a vaporeforming of natural gas or non-conventional methane-rich gases (such as, for example, firedamp or “coal bed methane” or “CBM” according to English terminology) or else a vaporeforming of light hydrocarbon fractions, preferably originating from the liquefaction process. In this case, the CO₂ that is produced during the gasification and/or the vaporeforming is preferably captured and stored. The gasification unit comprises a gasification reactor, a unit for eliminating acid gases, a gas-water conversion unit, a unit for absorption of CO₂, and a unit for purification of hydrogen. The gasification comprises an initial stage of pyrolysis followed by a partial oxidation that produces a synthetic gas that primarily comprises CO and hydrogen in variable contents. The oxidizing agent that is necessary for the gasification can be the oxygen that originates from a unit for air separation and/or preferably electrolysis of water that is used in the production of hydrogen that is generated by non-fossil sources. The synthetic gas is then washed in a unit for eliminating acid gases and then introduced into a gas-water conversion unit so as to increase the hydrogen content according to the reaction (CO+H₂O→CO₂+H₂). The effluent is then sent to an absorption unit for removing CO₂. In general, an absorber that uses solvents such as monoethanolamine (MEA), dimethylethanolamine (DMEA) or potassium carbonate (K₂CO₃) is used. The CO₂ that is captured in the absorption unit is then desorbed, compressed and used for the assisted recovery of petroleum and/or sequestered. The effluent that is low in CO₂ is sent to a unit for purification of the hydrogen that is typically an adsorption unit with regeneration by variation of pressure of the adsorbent (also called “pressure swing adsorption” or “PSA” according to English terminology) or a hydrogen membrane. The thus produced hydrogen can supplement the hydrogen that is generated by non-fossil sources for the requirements for liquefaction and/or subsequent refining (hydrotreatment and/or hydrocracking).

The coupling of the production of hydrogen that is generated by non-fossil sources via, for example, electrolysis, and the production of hydrogen that is generated by fossil sources via gasification and/or vaporeforming makes it possible to combine the two possible pathways for limiting the GHG emissions in the liquefaction of coal: the use of hydrogen produced from sources that do not emit greenhouse gas and the integration of the capture and storage of CO₂. In addition, this coupling makes it possible—by the use of the oxygen that is produced during electrolysis—to eliminate the air separation unit that is conventionally used to supply the gasification reactor with oxidizing agent. Thus, the oxygen that is necessary for the gasification preferably originates from the decomposition of the water by electrolysis.

The processes for capture and storage of CO₂ can also be carried out in the stage for production of hydrogen by gasification of biomass and that in the same way as described above in the case of the gasification of fossil sources Likewise, in the case of a production of hydrogen by electrolysis and by gasification of biomass, the oxygen of the electrolysis can supply the gasification.

The processes for capture and storage of CO₂ can also be carried out in the case of a biomass-non-fossil source co-gasification. Likewise, in the case of a production of hydrogen by electrolysis and by biomass-non-fossil source co-gasification, the oxygen of the electrolysis can supply the gasification.

### Liquefaction

Below, the process for conversion of carbon material by direct liquefaction is described for the case of coal. Nevertheless, it is applied in the same manner to other carbon feedstocks described above.

In this invention, the liquefaction of coal is carried out by a catalytic hydroconversion process in two successive boiling-bed-type reactors.

The coal/solvent suspension is introduced at the bottom of the liquefaction reactor that contains a boiling bed that operates with an upward flow of liquid and gas and that contains at least one hydroconversion-supported catalyst. The addition of hydrogen that is necessary for the operation is done by the make-up hydrogen produced in the stage for producing hydrogen that is generated by non-fossil sources, supplemented by the hydrogen recycled from the process and/or another accompanying refining process. The make-up hydrogen can also be supplemented by hydrogen that is generated by gasification and/or vaporeforming of fossil sources preferably including the capture and storage of the CO₂ that is produced.

During the liquefaction of coal, the reactions in the reactor(s) are as follows:
The deoxygenation reactions that are broken down into:
   The decarbonylation reaction that represents all of the reactions that make it possible to remove an oxygen atom and a carbon atom from a carboxylic group by forming carbon monoxide (CO),
   The decarboxylation reaction that represents all of the reactions that make it possible to remove a carboxyl group from a carboxylic group by forming carbon dioxide (CO₂),
   The hydrodeoxygenation reaction (HDO) that corresponds to the reactions that make it possible to remove oxygen from the feedstock and that end in the formation of water in the presence of hydrogen,
The hydrodesulfurization reaction (HDS), by which reference is made to the reactions that make it possible to remove sulfur from the feedstock with production of H₂S,
The hydrodenitrification reaction (HDN), by which reference is made to the reactions that make it possible to remove nitrogen from the feedstock with the production of NH₃,
The reaction for hydrogenation of unsaturations and/or aromatic cores (HDol, HDA),
More generally, all hydrotreatment reactions (HDT),
The hydrocracking reactions that lead to the opening of the naphthenic cycle or the fractionation of paraffins into several fragments of lower molecular weight (HCK),
The reactions of thermal cracking and polycondensation (formation of coke), although the latter are not desired,
Water-gas conversion reactions: CO+H₂O→CO₂+H₂
Methanation reactions: CO+3H₂→CH₄+H₂O.

All of the reactions that use hydrogen can be based on molecular hydrogen as in reactions for transfer of hydrogen atoms between the hydrogen donor solvent or the conversion products (since the donor solvent can originate from certain families of recycled conversion products) and the reagents.

The operation of the boiling-bed catalytic reactor, including the recycling of the liquids of the reactor upward through the stirred catalyst bed, is generally well known. The boiling-bed technologies use supported catalysts, generally in the form of extrudates whose diameter is generally on the order of 1 mm or less than 1 mm, for example greater than or equal to 0.7 mm. The catalysts remain inside the reactors and are not evacuated with the products. The catalytic activity can be kept constant by the in-line replacement (addition and removal) of the catalyst. It is therefore unnecessary to stop the unit for changing the used catalyst or to increase the reaction temperatures along the cycle for compensating for the deactivation. In addition, the fact of working under constant operating conditions makes it possible to obtain yields and qualities of products that are constant along the cycle. Also, because the stirring of the catalyst is maintained by a significant recycling of liquid, the pressure drop on the reactor is low and constant, and the reaction heat is quickly averaged over the catalytic bed, which is therefore nearly isothermal and does not require the injection of quenches. The implementation of the liquefaction in a boiling bed makes it possible to eliminate problems of contamination of the catalyst that are linked to deposits of impurities that are naturally present in the coal.

The technology of the boiling bed also makes it possible to carry out the conversion of coal by co-treatment with other feedstocks that are described above, whereby these feedstocks are often considered to be waste.

The fact of using two boiling-bed reactors makes it possible to have an improved operability at the level of the flexibility of the operating conditions and the catalytic system. The different possibilities for treatment of the used catalysts that are described below by regeneration and/or rejuvenation and/or cascade system (also called “cascading” according to English terminology) make it possible to increase the service life of the catalysts as well as the cycle durations of the entire process.

The procedure is usually performed under a pressure of 15 to 25 MPa, preferably 16 to 20 MPa, at a temperature of approximately 300° C. to 440° C., preferably between 325° C. to 420° C. for the first reactor (stage a)) and between 350° C. and 470° C., preferably between 350° C. and 450° C., for the second reactor (stage b)). The mass speed per hour is between 0.1 and 5 h⁻¹, and the amount of hydrogen mixed with the feedstock (coal and optionally other co-feedstock(s)) is usually approximately 0.1 to 5 normal cubic meters (Nm³) per kg of feedstock, preferably approximately 0.1 to 3 m³/kg, and most often approximately 0.1 to approximately 2 Nm³/kg in each reactor. After the first stage, the conversion of the feedstock is between 30 and 100%, and preferably between 50 and 99%, whereby the conversion can be defined relative to the insoluble products in THF, for example. The conversion of coal on a dry base is then everything that is not insoluble in THF.

The suspension is introduced into the first reactor that is kept at selected temperature and pressure conditions and in the presence of particles of a hydroconversion catalyst. The temperature of the reactor in this first liquefaction stage is lower than that of the second liquefaction stage. The selection of operating conditions, and in particular the selection of a temperature between 300° C. to 440° C., preferably between 325° C. to 420° C., makes possible the hydrogenation and the liquefaction of carbon at a conversion level that is already very high and simultaneously allows the hydrogenation of the solvent. The moderate temperature level limits the thermal cracking that leads to the formation of undesirable gases and limits the condensation of aromatic cores that lead to the formation of undesired coke. This reduces the deactivation of the catalyst and considerably extends the effective service life of the catalyst.

At least one portion of the effluent that is generated by the first liquefaction stage is then injected into a second liquefaction reactor that contains a supported catalyst in a boiling bed and that operates with an upward flow of liquid and gas and that contains at least one hydroconversion catalyst. The effluent is mixed with additional hydrogen that can be the make-up hydrogen produced by the stage for producing hydrogen that is generated by non-fossil sources and/or hydrogen recycled from the process and/or another accompanying refining process and/or hydrogen that is generated by gasification and/or vaporeforming of fossil sources, preferably including the capture and the storage of the CO₂ that is produced. This reactor, which operates in a way that is similar to the reactor of stage a), is used at a temperature that is at least approximately 10° C. higher than that of the reactor of stage a). The increase in temperature in the second reactor can be done by the addition of hot hydrogen (fresh or recycled). In general, the procedure is performed at a temperature of approximately 350° C. to 470° C., and preferably 350° C. to 450° C. The pressure of the reactor of stage b) is 0.1 to 1 MPa lower than for the reactor of stage a) to make possible the flow of at least a portion of the effluent that originates from stage a) without pumping being necessary. The catalyst that is used in stage b) can be identical to that of stage a).

In the reactor of stage b), the temperature that is higher than that of the first stage is selected for providing a more complete thermal and catalytic conversion of the coal that has not yet been converted. The hydroconversion of liquid products that is generated by the first stage and the thermal conversion of coal into liquids are emphasized as well as the reactions of hydrocracking, hydrodeoxygenation, decarboxylation, decarbonylation, hydrodesulfurization, and hydrodenitrification. The operating conditions are selected for minimizing the formation of gas or the formation of solids (generally called coke).

The different operating conditions in terms of temperature in the two hydroconversion stages are selected for being able to monitor the hydrogenation and the conversion of coal into desired products in each reactor and for simultaneously converting coal, recycled solvent, and liquids derived from coal during the liquefaction. The different operating conditions thus make possible the optimization of the use of hydrogen. The lower temperature in the first liquefaction reactor limits the formation of coke and the polymerization reactions while promoting the hydrogenation of the solvent. The hydrogenation of the solvent facilitates the transfer of hydrogen between the solvent and the coal and/or the conversion products all along the hydroconversion. The higher temperature in the second hydroconversion reactor makes it possible to convert the coal that is not yet converted.

Optionally, the effluent that is obtained at the end of the first liquefaction stage is subjected to a separation of the light fraction, and at least one part, preferably all, of the residual effluent is treated in the second hydroconversion stage. This separation is advantageously done in an inter-stage separator. The majority of the light fraction contains the compounds that boil at more than 300° C., and even at more than 450° C. This separation prevents the supercracking of the light fraction in stage b). It also makes it possible to reduce the economic investment on the reactor of stage b) (less feedstock to treat, less catalyst . . . ) or to bring an external feedstock to the reactor of stage b) or to increase the dwell time in the reactor of stage b). The hydrogen of the thus separated light fraction can be recycled in the process after purification. In such a way as to improve the separation of the light fraction, the majority of the bottom product of the inter-stage separator containing the heavy fraction and optionally a portion of the light fraction can be treated in a stage for vacuum distillation or liquid/liquid extraction or high-pressure stripping with hydrogen, for example.

Although the liquefaction in two liquefaction stages produces high yields of fuel bases, a third boiling-bed liquefaction reactor that operates at a higher temperature than that of the second reactor can be considered for certain feedstocks or mixtures of feedstocks of carbon material. In this case, the temperature of the third reactor is at least 10° C. higher than that of the second reactor. The possibility of an inter-stage separation of the effluent gases applies in the same way upstream from this third reactor.

The catalysts that are used for the liquefaction of coal are preferably catalysts that are known for the hydroconversion of residues of the petroleum industry. Hydroconversion is defined as hydrotreatment and/or hydrocracking reactions. In the two liquefaction stages, it is possible to use any conventional catalyst for hydrotreatment and/or hydroconversion of feedstocks of high molecular weight, in particular a granular catalyst that comprises, on a substrate, at least one metal or metal compound that has a hydro-dehydrogenating function.

This catalyst is advantageously a catalyst that comprises at least one metal from group VIII, generally selected from the group that is formed by nickel and/or cobalt, and optionally at least one metal of group VIB, preferably molybdenum and/or tungsten. For example, a catalyst that comprises 0.5 to 10% by weight of nickel and preferably 1 to 5% by weight of nickel (expressed in terms of nickel oxide NiO) and 1 to 30% by weight of molybdenum, preferably 5 to 20% by weight of molybdenum (expressed in terms of molybdenum oxide MoO₃), will be used on a mineral substrate. Advantageously, this substrate contains other doping compounds, in particular oxides that are selected from the group that is formed by boron oxide, zirconia, serine, titanium oxide, phosphoric anhydride, and a mixture of these oxides. Most often, an alumina substrate and very often an alumina substrate doped with phosphorus and optionally boron are used. The concentration of phosphoric anhydride P₂O₅ is usually between 0 or 0.1% and approximately 10% by weight. The concentration of boron trioxide B₂O₃ is usually between 0 and 0.1% and approximately 10% by weight. The alumina that is used is usually a γ- or η-alumina. This catalyst is most often in the form of extrudates. The total content of metal oxides of groups VIB and VIII is often from approximately 5 to approximately 40% by weight and in general from approximately 7 to 30% by weight, and the ratio by weight that is expressed in terms of metal oxide between metal (or metals) of group VIB to metal (or metals) of group VIII is in general from approximately 20 to approximately 1 and most often from approximately 10 to approximately 2.

The catalysts of the liquefaction stages of this invention can be identical or different in the reactors. Preferably, the catalysts that are used are based on cobalt-molybdenum or nickel-molybdenum on alumina.

Prior to the injection of the feedstock, the catalysts that are used in the process according to this invention are preferably subjected to a sulfurization treatment that makes it possible to transform, at least in part, the metal radicals into sulfide before they are brought into contact with the feedstock to be treated. This treatment of activation by sulfurization is well known to one skilled in the art and can be carried out by any method that is already described in the literature or in-situ, i.e., in the reactor, or ex-situ.

Each of the boiling-bed reactors comprises at least one means for removing the catalyst beyond said reactor that is located close to the bottom of the reactor and at least one means for adding fresh catalyst into said reactor that is located close to the top of said reactor. The addition of fresh catalyst and the removal of catalyst can optionally be implemented by the same pipe at the time that these two actions are not simultaneous.

The waste catalyst is partially replaced by fresh catalyst (new or regenerated) by removing at the bottom of the reactor and introducing at the top of the reactor fresh catalyst at regular time intervals, i.e., for example, in bursts or in an almost continuous fashion. It is possible, for example, to introduce fresh catalyst every day. The replacement rate of the waste catalyst by the fresh catalyst can be, for example, from approximately 0.05 kilogram to approximately 10 kilograms per ton of feedstock. This removal and this replacement are carried out using devices that make possible the continuous operation of the liquefaction stage. The unit usually comprises a pump for recirculation by reactor that makes possible the maintaining of the catalyst in a boiling bed by continuous recycling of at least a portion of the liquid that is removed from the upper part of the reactor and reinjected in the bottom of the reactor. It is also possible to send the waste catalyst that is removed from the reactor into a regeneration zone in which the carbon and the sulfur that it contains are eliminated, and then to send this regenerated catalyst to the first or the second or even the third liquefaction stage, optionally in addition to the fresh catalyst. It is also possible to send the waste catalyst that is removed from the reactor into a rejuvenation zone in which at least a portion of the deposited metals is eliminated before regenerating the catalyst by eliminating the carbon and the sulfur that it contains, and then sending this rejuvenated and regenerated catalyst to the first or to the second or even to the third stage of liquefaction optionally in addition to the fresh catalyst. The regeneration or rejuvenation stage can optionally be preceded by a stripping stage that makes possible the elimination of at least a portion of the hydrocarbons that are removed with the catalyst. The regeneration stage can optionally be followed by sulfurization before being returned to the first, the second, or the third liquefaction stage.

It is also possible to transfer—completely or partially—the waste catalyst that is removed from the reactor of stage a), operating at a lower temperature, directly to the reactor of stage b), operating at a higher temperature or transferring the waste catalyst that is removed from the reactor of stage b) completely or partially directly to the reactor of stage a). In the absence of co-treatment, it was noted that the catalyst is deactivated less in the reactor that operates at a temperature that is lower than in the reactor that operates at a higher temperature, apparently because of the lower operating temperature. However, in the case of a particular co-treatment where the feedstock(s) added to stage a) in addition to the feedstock of coal type introduced in stage a) can induce a faster deactivation of the catalyst in stage a) working at a lower temperature, a complete or partial transfer of the waste catalyst removed from the reactor of stage b), operating at a higher temperature, can be carried out directly to the reactor of stage a). This cascade system of the catalyst makes possible an extended service life of the catalyst. This principle can be extrapolated in the case of three reactors that are used in a series. The use of this cascade principle of the catalyst (or “cascading” in English) makes possible a better hydrogenation and liquefaction of coal per ton of fresh catalyst that is used or else a reduction of the quantity of fresh catalyst that is necessary for each ton of coal. In the case of “cascading,” the catalyst of the first and second reactor, and even of the third reactor, is identical. The stages of stripping and/or rejuvenation and/or regeneration and/or sulfurization of the catalyst that is removed can optionally be integrated in the implementation of the “cascading” of catalyst between two liquefaction reactors.

### Separation

For the purpose of producing fuel bases (naphtha, kerosene and/or diesel), the effluent that is obtained at the end of the liquefaction preferably undergoes a separation stage that makes it possible to separate a gaseous phase, at least one light fraction of liquid hydrocarbons such as naphtha, kerosene and/or diesel, a vacuum gas oil fraction, a vacuum waste, and a solid fraction that can be in the vacuum waste.

The separation stage can advantageously be implemented by any method that is known to one skilled in the art, such as, for example, the combination of one or more high- and/or low-pressure separators and/or distillation stages and/or high- and/or low-pressure stripping stages, and/or liquid/liquid extraction stages and/or solid/liquid separation stages and/or centrifuging stages.

In a preferred manner, the separation is carried out in a fractionation section that can first comprise a high-temperature, high-pressure separator (HPHT) and optionally a low-temperature, high-pressure separator (HPLT) and/or an atmospheric distillation and/or a vacuum distillation.

Advantageously, the effluent that is generated by the liquefaction first undergoes a gas/liquid separation stage. Preferably, the effluent of the second reactor is separated in a high-pressure, high-temperature (HPHT) separator from which a vapor phase and a liquid phase are recovered. The vapor phase can be sent to a high-pressure, low-temperature (HPLT) separator via a heat exchange device from which a vapor phase that contains the gases (H₂, H₂S, NH₃, H₂O, CO₂, CO, C1-C4 hydrocarbons, . . . ) and a liquid phase are recovered. The high-pressure, low-temperature (HPLT) separator can also treat the vapor phase that is generated by the inter-stage separator via a heat exchange device that may be common to the one that treats the vapor phase that is generated by the HPHT separator.

The liquid phase of the high-pressure, low-temperature (HPLT) separator is advantageously expanded in one or two low-pressure, low-temperature (LPLT) separators in such a way as to be at least partially degassed.

The gases that are extracted from the HPLT separator undergo a purification treatment for recovering hydrogen and recycling it to the liquefaction reactors. The same applies for the gaseous effluents that are obtained from optional subsequent treatment units, such as, for example, the hydrotreatment and/or hydrocracking of hydrocarbon fractions. It is also possible to add the gaseous phase that originates from the inter-stage separator.

The liquid phases that originate from the separators HPHT, HPLT and optionally LPLT are advantageously sent to a fractionation system. The fractionation system comprises an atmospheric distillation system and/or a vacuum distillation system for producing a gaseous effluent, so-called light fractions that are generated by the atmospheric distillation and that contain in particular naphtha, kerosene and/or diesel, a so-called heavy fraction that is generated by vacuum distillation and that contains vacuum gas oil (“VGO”) and a vacuum waste fraction. The products that are obtained can be integrated in fuel reservoirs (also called fuel “pools” according to English terminology) or can undergo additional refining stages that include a hydrotreatment and/or hydrocracking under high pressure of hydrogen. The fraction(s) of naphtha, kerosene, gas oil and vacuum gas oil can be subjected to one or more treatments (hydrotreatment, hydrocracking, alkylation, isomerization, catalytic reforming, catalytic cracking or thermal cracking, etc.) for enabling them to meet the required specifications (sulfur content, smoke point, octane, cetane, etc.) separately or in a mixture.

Preferably, all or part of the vacuum gas oil fraction is recycled in stage a) of the liquefaction. The recycling of this phase makes possible an increase of the yield of fuel bases because the portion of the recycled vacuum gas oil fraction represents the raw material for the hydrocracking reactions in the two liquefaction reactors. The recycling of this phase, acting as a hydrogen donor solvent, also makes it possible to provide a portion of the hydrogen that is necessary for the liquefaction. The fraction that is rich in vacuum gas oil can also be used as a base for the heavy fuels or bunker fuels or can be sent to refining units, such as units for hydrocracking or catalytic cracking.

From the vacuum distillation waste that contains unconverted feedstock(s), solids produced by undesirable reactions such as coke, and inorganic solids that are present as impurities or that originate from fines produced by attrition of the catalyst, the fraction point is generally selected in such a way that this initial boiling point of the heavy fraction is from approximately 450° C. to approximately 550° C. This heavy fraction is preferably recycled partially or completely as a feedstock in the case of a production of hydrogen by gasification of a fossil source. This solid feedstock can also be burned.

In an alternative manner, the fraction(s) generated by the HPHT and/or HPLT and/or LPLT separator(s) can be sent directly, or by increasing the pressure of these streams, separately or in a mixture, to subsequent refining stages such as hydrotreatment and/or hydrocracking. In the case where the effluents of the liquefaction section are treated in a HPHT separator and where the vapor phase of the HPHT separator is treated directly in additional refining stages such as hydrotreatment and/or hydrocracking, this configuration can be qualified as an integrated diagram that offers technico-economical advantages since the high-pressure streams do not require the increase in pressure for the purpose of their additional refining.

The separation stage is an optional stage. The effluent that is generated by the liquefaction stage may also not undergo such a stage for producing a synthetic crude that will be treated, after a possible hydrotreatment stage to stabilize it and an elimination of the lightest compounds (C3−), in an existing refinery. The separation stage can also be simplified as in the case of the integrated diagram that is mentioned above (without intermediate decompression).

### Post-Treatment

The upgrading of different fractions of fuel bases is not the object of this invention, and these methods are well known to one skilled in the art. The light fraction(s) and/or the vacuum gas oil fraction that are obtained after separation can partially or completely undergo a hydrotreatment and/or hydrocracking stage, with or without intermediate decompression. In a general manner, the naphtha can undergo hydrotreatment in a dedicated unit, or else it can be sent to a hydrocracking unit where it is brought to the characteristics of a feedstock that is acceptable in catalytic reforming and/or in isomerization. The kerosene and the gas oil that are produced can undergo hydrotreatment followed by a possible hydrocracking for being brought to meet the specifications (sulfur content, smoke point, cetane, content of aromatic compounds, etc.).

In a general manner, hydrotreatment and/or hydrocracking after liquefaction can be done either in a conventional way via a section of intermediate conventional separation as described above, or by integrating the hydrotreatment/hydrocracking section directly in the hydroliquefaction section with or without prior separation of the effluents and without intermediate decompression between the two stages.

### BRIEF DESCRIPTION OF THE FIGURES

FIG. 1 diagrammatically illustrates the liquefaction of coal in the presence of hydrogen that is produced by gasification of coal (conventional pathway).

FIG. 2 diagrammatically illustrates the liquefaction of coal in the presence of hydrogen that is produced from a non-fossil source, according to the invention.

FIG. 3 diagrammatically illustrates the liquefaction of coal in the presence of hydrogen that is produced from a non-fossil source, according to the invention, supplemented by the hydrogen that is produced by gasification of a fossil source.

FIG. 4 describes a preferred embodiment of the liquefaction in two stages according to this invention. Essentially the installation and the process according to the invention are described. The procedure is not performed with the operating conditions described above.

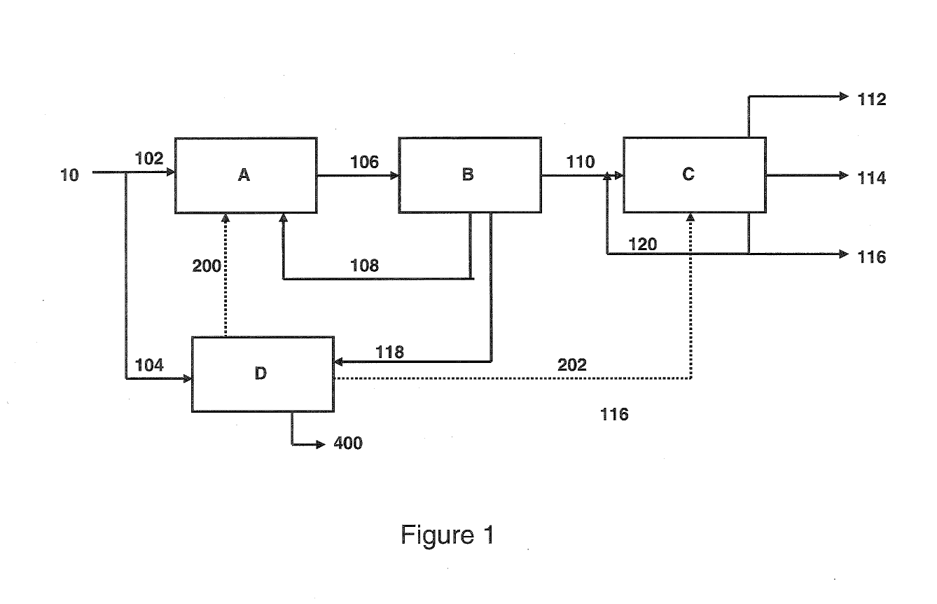

In FIG. 1, a portion of the coal (10) is introduced via the line 102 into the liquefaction unit (A), which diagrammatically represents the two liquefaction reactors. Another portion is introduced via the line 104 into the gasification unit (D) so as to produce hydrogen for the liquefaction (200) and optionally for the refining C (202), and CO₂ (400). The liquefaction effluent (106) is subjected to at least one separation stage (B) so as to separate at least one light fraction (110) that contains the gases, naphtha, light gas oil, and even heavy gas oil, a heavy vacuum gas oil fraction (108) and a vacuum waste fraction (118). A portion or all of the heavy vacuum gas oil fraction is recycled as solvent (108) in the liquefaction unit (A). A portion or all of the vacuum waste fraction can be recycled in the gasification unit (D) as feedstock (118). The light fraction(s) (110) that is/are obtained after the separation can undergo at least one refining stage (C), whereby the objective is to enable the different fractions to meet the specifications (sulfur content, smoke point, cetane, content of aromatic compounds, etc.). Thus, a gaseous fraction (112), at least one liquid fraction (naphtha, kerosene and/or diesel) (114), and a heavy fraction (116) are obtained. The heavy fraction (116) can be recycled at the input of Stage C until used up (120) or it can be sent to an FCC unit.

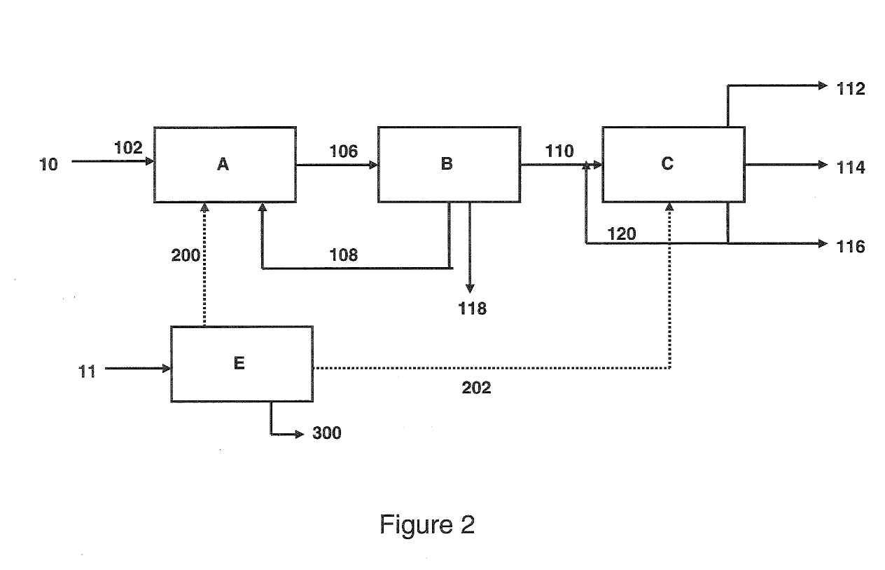

In FIG. 2, all of the coal (10) is introduced via line 102 into the liquefaction unit (A). The hydrogen (200) that is necessary for the liquefaction or the subsequent refining stages (202) originates, for example, from the decomposition of water (11), and it is produced by, for example, an electrolyzer (E) that also produces oxygen (300). Hydrogen can also be produced from hydrochloric acid, hydrogen chloride HCL, hydrogen sulfide H₂S, or from a biomass gasification (not shown). The effluent of the liquefaction (106) is subjected to at least one separation stage (B) so as to separate at least one light fraction (110) that contains gases, naphtha, kerosene, light gas oil, and even heavy gas oil, a heavy vacuum gas oil fraction (108) and a vacuum waste fraction (118). A portion or all of the heavy vacuum gas oil fraction is recycled as a solvent (108) in the liquefaction unit (A). A portion or all of the vacuum waste fraction (118) can be burned subsequently, can be used partially for the production of bitumens or as an adjuvant for the production of road bitumens, or can also be used as a feedstock in a gasification. The light fraction(s) (110) obtained after the separation can undergo at least one refining stage (C). Thus, a gaseous fraction (112), at least one liquid fraction (naphtha, kerosene and/or diesel) (114), and a heavy fraction (116) are obtained. The heavy fraction (116) can be recycled at the input of stage C until used up (120) or it can be sent to an FCC unit.

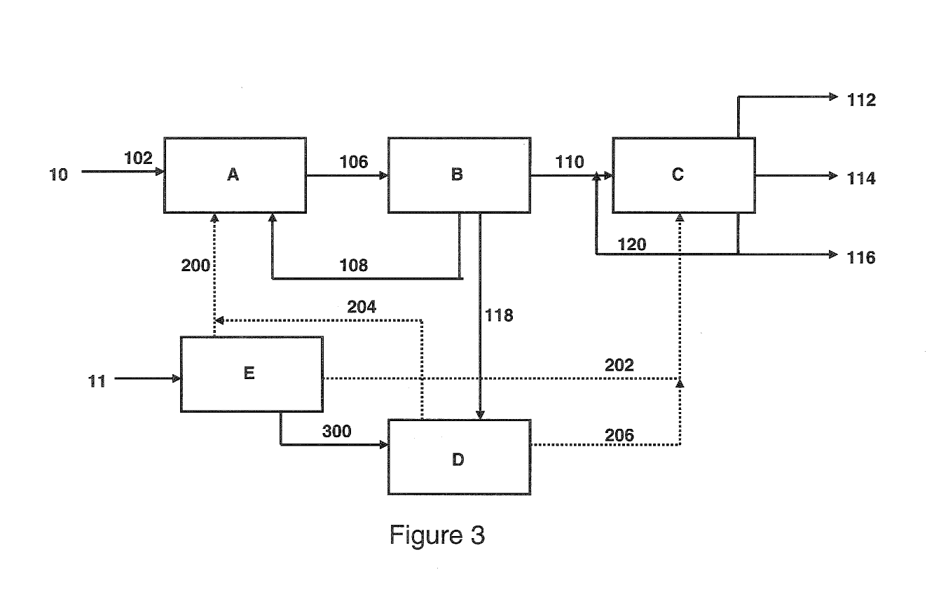

In FIG. 3, all of the coal (10) is introduced via the line 102 into the liquefaction unit (A). The hydrogen (200) that is necessary for the liquefaction or for the subsequent refining stages (202) originates from a hydrogen production stage that uses a non-fossil source (for example, the decomposition of water (11) and is produced by, for example, an electrolyzer (E) that also produces oxygen (300)), supplemented by a production of hydrogen (204) by gasification (D) of a fossil source, preferably the vacuum waste (118) that is generated by the liquefaction after separation. The hydrogen can also be produced from hydrochloric acid, hydrogen chloride HCl, hydrogen sulfide H₂S, or from a gasification of biomass (not shown). The effluent from the liquefaction (106) is subjected to at least one separation stage (B) so as to separate at least one light fraction (110) that contains gases, naphtha, kerosene, light gas oil, and even heavy gas oil, a heavy vacuum gas oil fraction (108) and a vacuum waste fraction (118). A portion or all of the heavy vacuum gas oil fraction can be recycled as a solvent (108) in the liquefaction unit (A). A portion or all of the vacuum waste fraction can be recycled in the gasification unit (D) as a feedstock (118). The light fraction(s) (110) obtained after the separation can undergo at least one refining stage (C). Thus, a gaseous fraction (112), at least one liquid fraction (naphtha, kerosene and/or diesel) (114) and a heavy fraction (116) are obtained. The heavy fraction (116) can be recycled at the input of stage C until used up (120) or can be sent to an FCC unit. The gasification unit (D) can be supplied by oxygen (300) produced in the electrolyzer (E). The hydrogen that is produced in the gasification is sent, as needed, into the liquefaction unit (A) via the line (204) and/or into the refining unit (C) via the line (206).

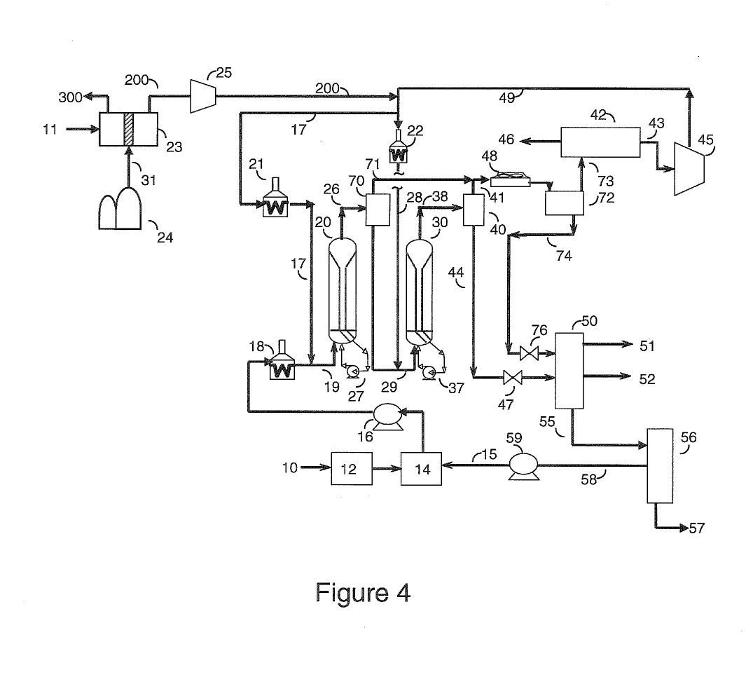

In FIG. 4, the coal (10), preferably pretreated in advance, and optionally pre-ground in such a way as to facilitate the pretreatment, for reducing its moisture content and its ash content, is ground in the mill (12) so as to produce particles of suitable size for forming a suspension and to be more reactive under the liquefaction conditions. The coal is then brought into contact with the recycling solvent (15) that is generated by the process in the chamber (14) for forming the suspension. If necessary, a sulfur compound for keeping the metals of the catalyst in sulfide form can be injected (not shown) in the line that exits from the chamber (14). The suspension is pressurized by the pump (16), preheated in the chamber (18), mixed with recycled hydrogen (17) that is heated in the chamber (21), and introduced via the pipe (19) at the bottom of the first reactor (20). The addition of hydrogen is supplemented by make-up hydrogen (200), produced by an electrolyzer (23) or by a gasification of biomass (not shown), and compressed (25) prior to its injection. The electrolyzer, fed by the electricity (31) that is generated by a nuclear power plant (24) (or any other non-fossil energy), breaks down the water (11) into oxygen (300) and hydrogen (200). Hydrogen can also be introduced (not shown) with the suspension into the furnace (18), thus eliminating the chamber (21). The boiling-bed reactor (20) operates with an upward flow of liquid and gas and contains at least one hydroconversion catalyst. It usually comprises a recirculation pump (27) that makes it possible to maintain the boiling-bed catalyst by continuous recycling of at least a portion of the liquid that is removed in the upper portion of the reactor and reinjected at the bottom of the reactor. The addition of fresh catalyst can be done at the top of the reactor (not shown). The waste catalyst can be removed at the bottom of the reactor (not shown) to be either eliminated or regenerated to eliminate the carbon and sulfur and/or rejuvenated for eliminating metals before its reinjection at the top of the reactor. The catalyst that is removed at the bottom of the first reactor that is partially waste can also be transferred directly into the top of the second hydroconversion reactor (30) (“cascading”) (not shown). Optionally, the converted effluent (26) that is generated by the reactor (20) can be subjected to a separation of the light fraction (71) in an inter-stage separator (70).

All or part of the effluent (26) that is generated by the first hydroconversion reactor (20) is advantageously mixed with the additional hydrogen (28), if necessary preheated in advance in the chamber (22). The hydrogen is recycled hydrogen and/or make-up hydrogen that originates from the electrolyzer (23) (or another non-fossil source). The hydrogen/effluent mixture (26) is injected by the pipe (29) into a second hydroconversion reactor (30) in a boiling bed that operates with an upward flow of liquid and gas containing at least one hydroconversion catalyst. The operating conditions, in particular the temperature, in this reactor are selected for reaching the desired conversion level, such as the one that was described in advance. The optional addition of fresh catalyst can be done at the top of the reactor (not shown). The addition of catalyst can be done periodically or continuously. The waste catalyst can be removed at the bottom of the reactor (not shown) to be either eliminated or regenerated to eliminate the carbon and sulfur and/or rejuvenated to eliminate the metals before its reinjection at the top of the reactor. The reactor (30) usually comprises a recirculation pump (37) making it possible to maintain the boiling-bed catalyst by continuous recycling of at least a portion of the liquid that is removed from the upper portion of the reactor and reinjected at the bottom of the reactor. The effluent that is treated in the reactor (30) is sent via the line (38) into a high-pressure, high-temperature (HPHT) separator (40) from which a vapor phase (41), so-called light fraction, and a liquid phase (44), so-called residual fraction, are recovered. The vapor phase (41) is sent, optionally mixed with the vapor phase (71), generated by the optional inter-stage separator (70) between the two liquefaction reactors, generally via an exchanger (not shown) or a cooling tower (48) for cooling a high-pressure, low-temperature (HPLT) separator (72) from which a vapor phase (73) that contains the gases (H₂, H₂S, NH₃, H₂O, CO₂, CO, C1-C4 hydrocarbons, . . . ) and a liquid phase (74) are recovered.

The vapor phase (73) of the high-pressure, low-temperature (HPLT) separator (72) is treated in the hydrogen purification unit (42) from which the hydrogen (43) is recovered for recycling it via the compressor (45) and the line (49) to the reactors (20) and/or (30). The gases that contain undesirable nitrogen, sulfur and oxygen compounds are evacuated from the installation (stream (46)).

The liquid phase (74) of the high-pressure, low-temperature (HPLT) separator (72) is expanded in the device (76) and then sent to the fractionation system (50). Optionally, a medium-pressure separator (not shown) after the expander (76) can be installed for recovering a vapor phase that is sent to the purification unit (42) and a liquid phase that is brought to the fractionation section (50).

The liquid phase (44) that is generated by the high-pressure, high-temperature (HPHT) separation (40) is expanded in the device (47) and then sent to the fractionation system (50). Quite obviously, the fractions (74) and (44) can be sent together, after expansion, into the system (50). The fractionation system (50) comprises an atmospheric distillation system for producing a gaseous effluent (51), a so-called light fraction (52) that contains in particular naphtha, kerosene and diesel, and a so-called heavy fraction that contains vacuum gas oil (55). All or part of the heavy fraction (55) is sent to a vacuum distillation column (56) for recovering a phase (57) that contains vacuum waste, unconverted coal and ash, and a liquid phase (58) that contains vacuum gas oil. This solid fraction (57) can be burned subsequently, can be used in part for the production of bitumens or as an adjuvant for the production of road bitumens, or can also be used as a feedstock in gasification. The liquid phase (58) is used at least partially as a solvent for the liquefaction and is recycled after pressurization (59) via the pipe (15) in the chamber (14) to be mixed with coal.

### EXAMPLES

The following examples illustrate the invention that is described without, however, limiting its scope. Example 1 (not in accordance with the invention) relates to the liquefaction of coal in two stages according to the conventional pathway using hydrogen that is produced by the gasification of coal. Example 2 (according to the invention) relates to the liquefaction of coal in two stages by using hydrogen that is produced by a non-fossil source.

### Example 1

### Not in Accordance with the Invention

Coal of the Illinois No. 6 type was pretreated, then having an ash content close to 6% by weight of dry coal. The coal is then subjected to a two-stage liquefaction according to the H-Coal TS® process. The operating conditions of the liquefaction appear in Table 1. The hydrogen that is necessary to the liquefaction originates from a gasification of coal. The performance levels of the overall coal liquefaction chain are described in Table 3.

TABLE 1
Operating Conditions of the Two-Stage Liquefaction

| Catalyst | NiMo/Alumina |
|---|---|
| Temperature of Reactor R1 (° C.) | 410 |
| Temperature of Reactor R2 (° C.) | 440 |
| Pressure, MPa | 17 |
| VVH of R1 (kg/h of Dry Coal/kg of | 1.2 |
| Catalyst) | |
| VVH of R2 (kg/h of Dry Coal/kg of | 1.2 |
| Catalyst) | |
| Input H₂ (Nm³/kg of Dry Coal) | 2.8 |
| Liquid/Carbon Recycling | 1.1 |

According to Table 3, the direct liquefaction process H-Coal TS® produces 3.9 barrels of liquid hydrocarbons (LPG+naphtha+diesel) per ton of dry coal without ash. This value integrates the production of hydrogen. Per 100 tons of coal, 68 tons are dedicated to the liquefaction and 32 tons to the production of hydrogen. Furthermore, the final products are considered to meet the required specifications. 57.5% of carbon that is contained in the coal is incorporated in the products SNG+LPG+naphtha+diesel.

The quantity of CO₂ emitted per kg of liquid bases is calculated from the following expression:

$$kg of emitted {CO}_{2} \text{/} kg of liquid bases = \frac{Generated {CO}_{2} ( kg \text{/} h )}{S N G + L P G + naphtha + diesel ( kg \text{/} h )}$$

in which SNG means “synthetic natural gas” according to the English terminology for natural synthetic gas, and “LPG” means liquefied petroleum gas. Furthermore, it is considered that 80% of the CO₂ emissions originates from the gasification of coal for the production of hydrogen. So as to estimate the quantity of CO₂ that is produced, it is assumed that all of the carbon injected at the input of the unit and not incorporated in the upgradable products (SNG, LPG, naphtha, diesel) will be found at the output of the unit in CO₂ form. The production of one kilogram of the “SNG+LPG+naphtha+diesel” products emits 2.5 kg of CO₂.

### Example 2

### According to the Invention

The liquefaction of Example 1 was repeated under the same operating conditions (Table 1). The hydrogen originates from electrolysis of water using electricity generated by a nuclear power plant. The 388° C.⁺ fraction, obtained after the separation of the effluent from the liquefaction and representing approximately 12% by weight of the coal liquefiers (organic fraction+undissolved coal), is not upgraded as fuel in this example. It is subjected to combustion (or oxycombustion by using the O₂ that is produced by electrolysis), then producing heat and CO₂.

The performance levels of the liquefaction that use hydrogen generated by a non-fossil source are synthesized in Table 3.

TABLE 3
Performance Levels of the Direct Pathway of Liquefaction of Coal for the
Production of Fuels - H-Coal TS ® Process - Addition of Hydrogen
from Fossil and Non-Fossil Sources

| | Example 1 | Example 2 |
|---|---|---|
| Hydrogen Source | Gasification | Electrolyzer |
| Carbon Feedstock for | 100 | 100 |
| Liquefaction and | | |
| Gasification* (t/h) | | |
| Yield (t/h): | | |
| C1 + C2 (Synthetic Natural | 3.79 | 4.48 |
| Gas or “SNG”) | | |
| C3 + C4 (Liquefied | 3.44 | 10.5 |
| Petroleum Gas, LPG) | | |
| Naptha (C5 - 180° C.) | 11.63 | 18.00 |
| Diesel (180 - 388° C.) | 30.71 | 38.00 |
| C4-388° C. | 43.92 | 56.1 |
| Coal Conversion (bbl/t of | 3.90 | 5.65 |
| Dry Coal Apart from Ash) | | |
| Yield of Liquid Bases (% of | 57.5 | 82.2 |
| Carbon Contained in the | | |
| Coal that is Incorporated in | | |
| the SNG + LPG + Naphtha + | | |
| Diesel Products) | | |
| kg of CO₂/kg of Liquid | 2.5 | 0.7 |
| Bases | | |

*Gasification only for Example 1

Relative to the conventional diagram (Example 1), the conversion of coal into liquid products is increased by 43%. 82.2% of the carbon contained in the coal is incorporated in the SNG-LPG-naphtha-diesel products versus 57.5% by the conventional pathway. Despite the complete combustion of the 400° C.⁺ fraction, a significant reduction of the CO₂ emissions follows therefrom: the production of one kilogram of “SNG+LPG+naphtha+diesel” products emits 0.7 kg of CO₂ versus 2.5 by the conventional pathway. It should be noted that for the indirect pathway, this value is estimated at 4.3 kg.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding FR application Ser. No. 10/03.046, filed Jul. 20, 2010, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Process for converting carbon material into fuel bases comprising the following stages:
a) Liquefaction of said carbon material in the presence of hydrogen in at least one reactor that contains a catalyst that is supported in a boiling bed,
b) Liquefaction of at least a portion of the effluent that is obtained in stage a) in the presence of hydrogen in at least one reactor that contains a catalyst that is supported in a boiling bed and that operates at a temperature that is at least 10° C. higher than that of stage a),
whereby said process is characterized in that it comprises a hydrogen production stage that uses at least one non-fossil source, with the thus produced hydrogen being at least partially or completely introduced into at least one of the liquefaction stages.

2. Process according to claim 1, wherein said non-fossil source is water, hydrochloric acid, hydrogen chloride, hydrogen sulfide and/or biomass.

3. Process according to claim 2, wherein the hydrogen production stage comprises the decomposition of water by electrolysis, by high-temperature electrolysis, by thermochemical cycles and/or by microorganisms.

4. Process according to claim 2, wherein the hydrogen production stage comprises the electrolysis of hydrochloric acid and/or the reaction of hydrogen chloride with cerium dioxide.

5. Process according to claim 2, wherein the hydrogen production stage comprises the decomposition of hydrogen sulfide by heat treatment and/or by reaction of metal oxides.

6. Process according to claim 2, wherein the hydrogen production stage comprises the gasification of biomass.

7. Process according to claim 1, wherein the energy that supplies the hydrogen production stage is a non-fossil energy that is selected from among the group that is formed by nuclear energy, photovoltaic solar energy, low-temperature thermal solar energy, high-temperature thermal solar energy, wind energy, hydraulic energy or hydroelectricity, marine energies, geothermal power and/or biomass, alone or in combination with two or more of them in equal or different proportions.

8. Process according to claim 1, wherein said carbon material is a feedstock that is selected from among the group that is formed by coal, biomass, algae, feedstocks that are generated by petroleum and/or petroleum refining, products that are generated by thermochemical or hydrothermal conversion of these feedstocks, and/or hydrocarbon wastes, alone or in a mixture of two or more of them in equal or different proportions.

9. Process according to claim 1, comprising a stage for producing hydrogen by gasification of at least one fossil source that is selected from among coal, petroleum waste, and/or waste that is generated by liquefaction, or by vaporeforming of natural gas, non-conventional methane-rich gas, and/or light hydrocarbon fractions, whereby the thus produced hydrogen is at least partially or completely introduced into at least one of the liquefaction stages.

10. Process according to claim 9, wherein the oxygen that is necessary for the gasification originates from the decomposition of water by electrolysis.

11. Process according to claim 1, further comprising processes for capture and storage of CO₂ from emissions that are emitted during the production of utilities and/or during the production of hydrogen.

12. Process according to claim 11, wherein said process for capture of CO₂ comprises a process for absorption by amines and/or by potassium carbonate.

13. Process according to claim 1, wherein the effluent that is obtained at the end of the liquefaction stages undergoes a separation stage that makes it possible to separate a gaseous phase, at least one light fraction of liquid hydrocarbons such as naphtha, kerosene and/or diesel, a vacuum gas oil fraction, a vacuum waste, and a solid fraction that can be in the vacuum waste.

14. Process according to claim 13, wherein said vacuum gas oil fraction is recycled partially or completely in stage a).

15. Process according to claim 13, wherein the light fraction(s) and/or said vacuum gas oil fraction next partially or completely undergo(es) a hydrotreatment and/or hydrocracking stage with or without intermediate decompression.
